(19) United States
(12) Patent Application Publication
(10) Pub. No.: US 2010/0230520 A1
(43) Pub. Date: Sep. 16, 2010

(54) Mill for milling rough, stone-like bulk material with parallel to the axis drive

(76) Inventors: Christian Brammer, Berlin (DE); Ines Junge, Berlin (DE); Wolf Krieger, Berlin (DE); Axel Möhle, Berlin (DE); Christian Schiller, Berlin (DE)

Correspondence Address: King & Spalding LLP, 401 Congress Avenue, Suite 3200, Austin, TX, 78701, US

(21) Appl. No.: 12/440,884

(22) PCT Filed: Aug. 21, 2007
(86) PCT No.: PCT/EP07/58667

§ 371 Date: Dec. 14, 2009

(30) Foreign Application Priority Data
Sep. 14, 2006 (DE) 10 2006 043 179.0

(51) Int. Cl. B02C 9/00

(52) U.S. Cl. 241/30; 241/277

(57) ABSTRACT

The invention relates to a mill for milling rough, stone-like bulk material, comprising a milling plate (4) turnable around a vertical rotation axis (5). The milling plate (4) is driven by an electric motor (6), comprising a crankshaft (7) and a shaft axis (8). The electric motor (6) is arranged directly under the milling plate (4). The shaft axis (8) runs perpendicular.

The present invention relates to a mill for grinding rough, stone-like bulk material, for example ore or coal, having a grinding table rotatable about a vertical rotation axis, wherein the grinding table can be driven by means of an electric motor which has a motor shaft with a shaft axis.

Such mills are generally known and are sold, for example, by Polysius AG, Germany, under the model designations Dorol and Quadropol. A diagram of such a mill can be retrieved, for example, at the Internet address http://www.polysius.com/imageneutraldetailbild.asp?id=353.

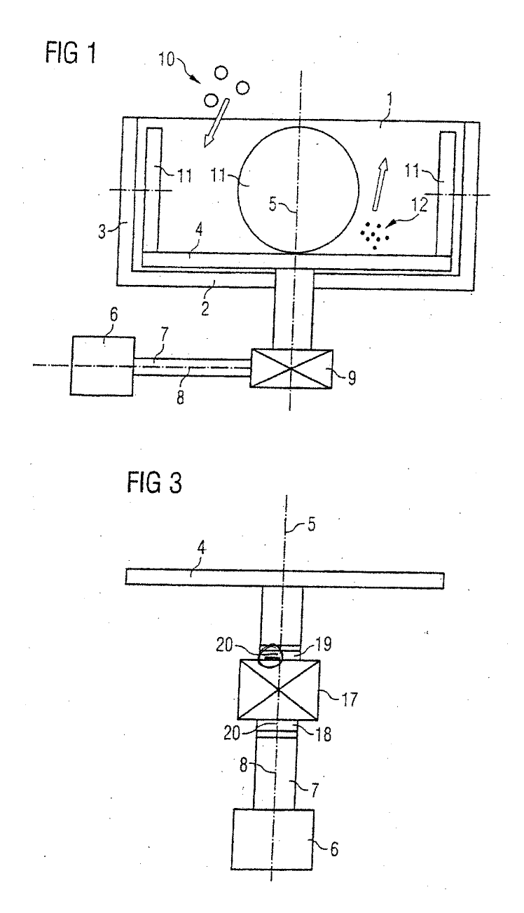

The known mill is explained below in conjunction with FIG. 1, insofar as this is necessary for understanding the present invention.

According to FIG. 1, the mill has a grinding chamber 1. The grinding chamber 1 has a grinding chamber base 2 and a grinding chamber wall 3 running around the grinding chamber 1. A grinding table 4 is mounted on the grinding chamber base 2 in such a way that it is rotatable about a vertical rotation axis 5.

The grinding table 4 can be driven by means of an electric motor 6. The electric motor 6 has a motor shaft 7 with a shaft axis 8.

In the prior art, the electric motor 6 is arranged laterally under the grinding table 4. The shaft axis 8 runs horizontally. The motor shaft 7 acts on the grinding table 4 via a deflection or angular gear unit 9—e.g. a bevel gear unit. The deflection gear unit 9, in addition to the deflection, converts a relatively high speed of the electric motor 6 to a markedly lower speed of the grinding table 4.

Rough, stone-like bulk material 10, for example lumps of coal or ore, is fed to the grinding chamber 1 in a known manner—for example by means of a delivery chute (not shown). On account of the centrifugal force, the bulk material 10 is directed radially outward in the direction of the grinding chamber wall 3. The bulk material 10 is ground there by means of grinding rollers 11 which roll on the grinding table 4. The grinding rollers 11 are as a rule not driven themselves. However, driving of the grinding rollers 11 would be possible. The ground bulk material—designated as ground stock 12 to distinguish it from the unground bulk material 10—is discharged from the grinding chamber 1 in a known manner, for example by means of a blower (not shown).

The known mill works very well, but is of relatively complicated construction and costly. The deflection gear unit 9 is also relatively susceptible to faults and requires a lot of maintenance.

The object of the present invention is to improve the known mill in such a way that it can be produced in a simpler and more cost-effective manner, is simpler to maintain in continuous operation and is less susceptible to faults.

The object is achieved in a mill of the type mentioned at the beginning in that the electric motor is arranged directly under the grinding table and the shaft axis runs perpendicularly.

Due to the configuration according to the invention, it is possible to connect the motor shaft to the grinding table directly, i.e. without a gear unit arranged in between. If a gear unit is present, the motor shaft certainly continues to be connected to the grinding table only via a gear unit. However, in the configuration according to the invention, the gear unit can have a gear unit input shaft and a gear unit output shaft which have rotation axes parallel to one another. In a preferred

configuration, the rotation axes of the gear unit input shaft and of the gear unit output shaft (and consequently also the shaft axis and the rotation axis) are even in alignment with one another. An example of a gear unit which has rotation axes in alignment with one another is an epicyclic gear unit, which has a sun gear, at least one planet gear and a ring gear.

In the case of an epicyclic gear unit, various combinations are possible, with which the gear unit input shaft and the gear unit output shaft interact with gears of the epicyclic gear unit. Depending on the configuration of the epicyclic gear unit, the gear unit input shaft can be connected in a rotationally fixed manner to the sun gear, the ring gear or a bearing arrangement on which the at least one planet gear is rotatably mounted about the sun gear. Likewise, the gear unit output shaft can be connected in a rotationally fixed manner to the sun gear, the ring gear or the bearing arrangement of the planet gear. Of course, in an actual specific configuration of the epicyclic gear unit, the gear unit input shaft and the gear unit output shaft must not be connected to the same element (sun gear, ring gear, bearing arrangement of the planet gear).

It is currently preferred for the motor shaft to be connected to the sun gear. In this case, the grinding table is connected in a rotationally fixed manner either to the ring gear or to the bearing arrangement for the at least one planet gear.

The electric motor is preferably designed as a low-speed, high-pole drive. Alternatively, it may be designed as an asynchronous motor or as a synchronous motor. In the case of a synchronous motor, the drive may alternatively be excited electrically or permanently magnetically. Furthermore, the electric motor may alternatively be designed as an internal-rotor motor or as an external-rotor motor. The electric motor may be fed directly from the supply network or—preferably—via a converter.

Further advantages and details follow from the description below of exemplary embodiments in conjunction with the drawings, in which, in diagrammatic illustrations:

FIG. 1 shows a mill of the prior art,

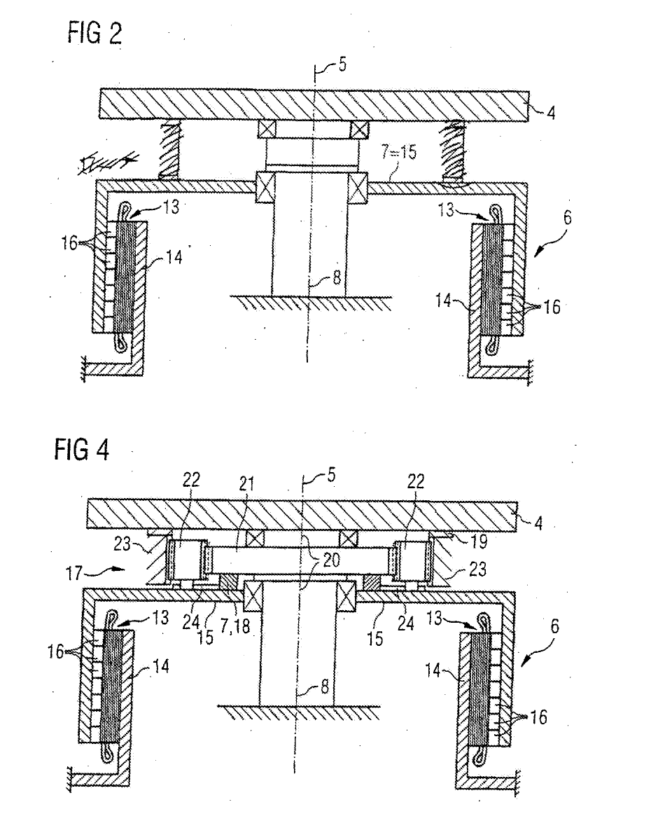

FIG. 2 shows a grinding table with electric direct drive, and

FIGS. 3 and 4 show a grinding table with drive via a gear unit.

The description below of the present invention and of its configurations is based on the mill described above in conjunction with FIG. 1. Only the differences of the configurations according to the invention are therefore dealt with in more detail below. The other statements with respect to FIG. 1 still apply.

Furthermore, the present invention is described in conjunction with a permanently excited synchronous motor which is designed as an external-rotor motor. However, it would be readily possible to use, instead of the permanently excited synchronous motor, an electrically excited synchronous motor or an asynchronous motor and/or to design the motor as an internal-rotor motor.

According to FIG. 2, the electric motor 6 is arranged directly under the grinding table 4. It has a stator winding 13 which is fastened to a stator holder 14. The stator winding 13 interacts with a rotor 15 which in the present case has permanent magnets 16. The rotor 15 is preferably of bell-shaped design. It can be mounted on the motor shaft 7 or can terminate it. According to FIG. 2, the shaft axis 8 of the motor shaft 7 runs perpendicularly.

In the configuration in FIG. 2, the motor shaft 7 is connected to the grinding table 4 directly, that is to say without a gear unit in between. The shaft axis 8 of the motor shaft 7 is therefore in alignment with the rotation axis 5 of the grinding table 4.

If necessary, the grinding table 4 can be supported radially on the outside and/or between its radially outer end and the motor shaft 7. In the case of a bell-shaped configuration of the rotor 15, the rotor 15 can even be identical to the grinding table 4.

The illustration in FIG. 3 schematically corresponds essentially to the illustration in FIG. 2. In contrast to the configuration in FIG. 2, however, the grinding table 4 in the configuration in FIG. 3 is connected to the motor shaft 7 via a gear unit 17. The gear unit 17 has a gear unit input shaft 18 and a gear unit output shaft 19. The gear unit input shaft 18 and the gear unit output shaft 19 have rotation axes 20 which run parallel to one another. The rotation axes 20 may be offset. However, they are preferably in alignment with one another.

According to FIG. 4, which shows a special form of the configuration in FIG. 3, the gear unit 17 is designed as an epicyclic gear unit 17. It has a sun gear 21, at least one planet gear 22 and a ring gear 23. According to the configuration in FIG. 4, the motor shaft 7 is connected to the sun gear 21 in a rotationally fixed manner.

According to FIG. 4, the grinding table 4 is connected to the ring gear 23 in a rotationally fixed manner. The at least one planet gear 22 is rotatably mounted on a bearing arrangement 24. The bearing arrangement 24 is rotatable relative to the sun gear 21 and relative to the ring gear 23.

As an alternative to the configuration in FIG. 4, the grinding table 4 could also be connected to the bearing arrangement 24 in a rotationally fixed manner.

By means of the present invention, it is possible to replace the electric motor 6 of the prior art running at a relatively high speed with an electric motor 6 running at a considerably lower speed. The deflection gear unit 9, which requires a lot of maintenance and is susceptible to faults, can either be dispensed with or be replaced with a considerably more reliable gear unit 17 which has

shafts 18, 19 running in parallel. Gear friction losses do not occur or can be reduced. The efficiency and the availability of the mill according to the invention are greater than in the prior art. Higher specific outputs can also be realized.

The above description serves solely to explain the present invention. However, the scope of protection of the present invention is to be determined solely by the attached claims.

1. A mill for grinding rough, stone-like bulk material comprising a grinding table rotatable about a vertical rotation axis, wherein the grinding table is driven by means of an electric motor which has a motor shaft with a shaft axis, wherein the electric motor is arranged directly under the grinding table and the shaft axis runs perpendicularly, and wherein the electric motor is designed as an external-rotor motor.

2. The mill according to claim 1, wherein the motor shaft is connected directly to the grinding table.

3. The mill according to claim 1, wherein the motor shaft is connected to the grinding table via a gear unit which has a gear unit input shaft and a gear unit output shaft, and wherein the gear unit input shaft and the gear unit output shaft have rotation axes parallel to one another.

4. The mill according to claim 3, wherein the rotation axes of the gear unit input shaft and of the gear unit output shaft are in alignment with one another.

5. The mill according to claim 4, wherein the gear unit is designed as an epicyclic gear unit, which has a sun gear, at least one planet gear and a ring gear.

6. The mill according to claim 5, wherein the motor shaft is connected to the sun gear in a rotationally fixed manner, and the grinding table is connected in a rotationally fixed manner either to the ring gear or to the bearing arrangement on which the at least one planet gear is rotatably mounted.

7. The mill according to claim 5, wherein a rotor of the external-rotor motor is of bell-shaped design.

8. The mill according to claim 1, wherein the rough, stone-like bulk material is ore or coal.

9. A method for grinding rough, stone-like bulk material comprising the steps of:
arranging a grinding table rotatable about a vertical rotation axis,
driving the grinding table by means of an electric motor which has a motor shaft with a shaft axis, wherein the electric motor is arranged directly under the grinding table and the shaft axis runs perpendicularly, and wherein the electric motor is designed as an external-rotor motor.

10. The method according to claim 9, comprising the steps of connecting the motor shaft directly to the grinding table.

11. The method according to claim 9, comprising the steps of connecting the motor shaft to the grinding table via a gear unit which has a gear unit input shaft and a gear unit output shaft, wherein the gear unit input shaft and the gear unit output shaft have rotation axes parallel to one another.

12. The method according to claim 11, comprising the steps of aligning the rotation axes of the gear unit input shaft and of the gear unit output shaft with one another.

13. The method according to claim 12, comprising the steps of designing the gear unit as an epicyclic gear unit, which has a sun gear, at least one planet gear and a ring gear.

14. The method according to claim 13, comprising the steps of connecting the motor shaft to the sun gear in a rotationally fixed manner, and connecting the grinding table in a rotationally fixed manner either to the ring gear or to the bearing arrangement on which the at least one planet gear is rotatably mounted.

15. The method according to claim 13, wherein a rotor of the external-rotor motor is of bell-shaped design.

16. The method according to claim 9, wherein the rough, stone-like bulk material is ore or coal.
